(19) United States
(12) Patent Application Publication
(10) Pub. No.: US 2010/0161874 A1
(43) Pub. Date: Jun. 24, 2010

(54) MULTIPLE SLOT MEMORY SYSTEM

(75) Inventor: Siva RaghuRam Chennupati, Unterschleissheim (DE)

Correspondence Address: TEXAS INSTRUMENTS INCORPORATED, P O BOX 655474, M/S 3999, DALLAS, TX, 75265, US

(73) Assignee: Texas Instruments Deutschland GmbH, Freising (DE)

(21) Appl. No.: 12/388,337

(22) Filed: Feb. 18, 2009

Related U.S. Application Data
(60) Provisional application No. 61/141,401, filed on Dec. 30, 2008.

(30) Foreign Application Priority Data
Dec. 20, 2008 (DE) 10 2008 009 951.1

(51) Int. Cl. G06F 12/06

(52) U.S. Cl. 711/5; 711/E12.082

(57) ABSTRACT

A memory system having a memory controller plus one or more registered memory modules, each registered memory module having a bank of memory chips and an associated register. A pre-register address/command bus connects the memory controller with the associated register. Each registered memory module has a post-register command/address bus that connects the memory chips in parallel with the associated register. The post-register command/address bus terminates with termination resistors that are connected to a voltage level that is approximately half of the supply voltage level. The memory controller provides chip select signals to the associated register of the registered memory modules. The associated registers, however, switch command/address signals to the memory chips independent of the chip select signals.

This patent application claims priority from German Patent Application No. 10 2008 009 951.1, filed 20 Feb. 2008, and from U.S. Provisional Patent Application No. 61/141,401, filed 30 Dec. 2008, the entireties of which are incorporated herein by reference.

### FIELD OF THE INVENTION

The present invention relates to a memory system that includes a memory controller and one or more memory modules, each with a bank of memory chips.

### BRIEF DESCRIPTION OF THE DRAWINGS

Further features and advantages of the invention will be apparent from the following description of example embodiments, with reference to the accompanying drawings, wherein:

FIG. 1 is a schematic diagram of a conventional multiple slot memory system;

FIG. 2 is a similar diagram of the inventive multiple slot memory system;

FIG. 3 is a schematic diagram of a DDR3 memory module; and

FIG. 4 is an exemplary signal diagram of CA signals on a post-register CA bus.

### DETAILED DESCRIPTION OF EXAMPLE EMBODIMENTS

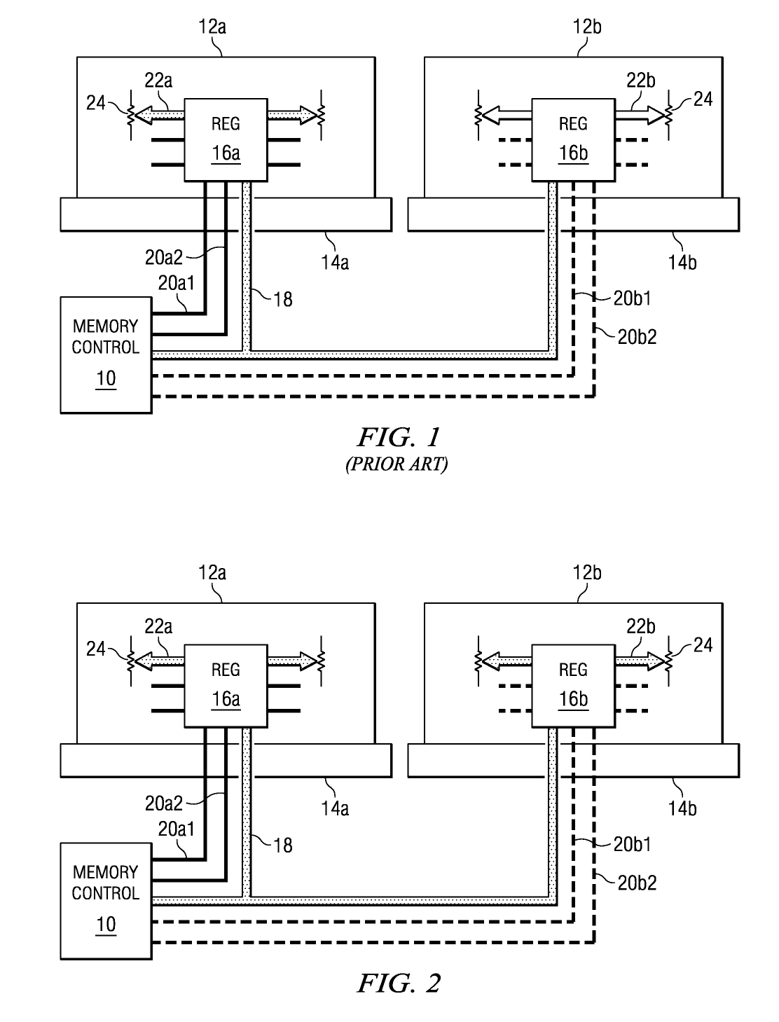

A memory system for a PC or server typically has a memory controller and a plurality of RAM modules. In FIG. 1, a memory controller 10 is associated with a number of registered DIMMs 12a, 12b, . . . plugged into corresponding sockets or “slots” 14a, 14b, . . . Each DIMM 12a, 12b . . . has an associated register 16a, 16b, The memory controller 10 is connected to each register 16a, 16b . . . through a pre-register command/address (CA) bus 18 and through a pair of chip select lines 20a1 and 20a2, 20b1, 20b2 . . . Each DIMM has a post-register CA bus 22a, 22b . . . to which all memory chips (not shown) are connected in parallel. The post-register bus 22a, 22b . . . is terminated with a termination resistor 24 on both ends. The termination resistor 24 is connected to a voltage level that is approximately half of the supply voltage for the memory modules. For simplicity, other connections such as the clock and data connections are not shown in the figures.

In FIG. 1, active chip select lines 20a1 and 20a2 are shown with full lines and inactive chip select lines 20b1 and 20b2 are shown in dotted lines. Only register 16a, which receives active chip select signals, switches the CA signals received from the pre-register bus 18 to the associated post-register CA bus 22a, as indicated by a hatched arrow, and register 16b, which receives inactive chip select signals, blocks the CA signals from being switched to the associated post-register CA bus 22b, as indicated by a hollow arrow.

In FIG. 2, the chip select lines 20a1 and 20a2 are active whereas chip select lines 20b1 and 20b2 are inactive. However, (different from FIG. 1) register 16b is also switching the CA signals from pre-register CA bus 18 onto the associated post-register bus 22b, as indicated by a hatched arrow. In fact, all registers of all memory modules in the memory system switch the CA signals (from the pre-register CA bus 18 onto the associated post-register bus) independent of the chip select signals 20a1, 20a2, 20b1, 20b2 . . . received from the memory controller 10.

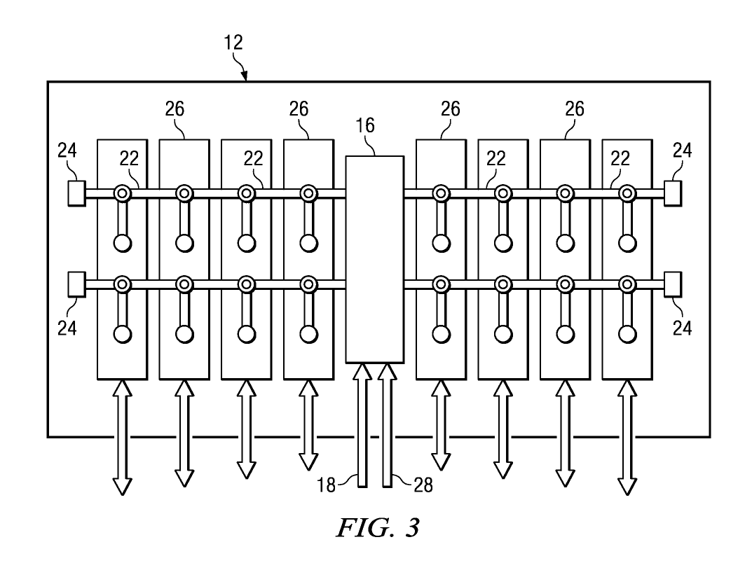

FIG. 3 is a schematic illustration of a single registered memory module 12 (RDIMM). A number of memory chips 26 are aligned on a circuit board on both sides of register 16 and in parallel along post-register CA bus 22. As is seen, the post-register CA bus 22 is terminated at each of its outer ends with a termination resistor 24. Inputs to the register 16 are the pre-register CA bus 18 and a pre-register clock 28 received from the memory controller 10. The signal clock is also applied in parallel to all memory chips 26 by register 16.

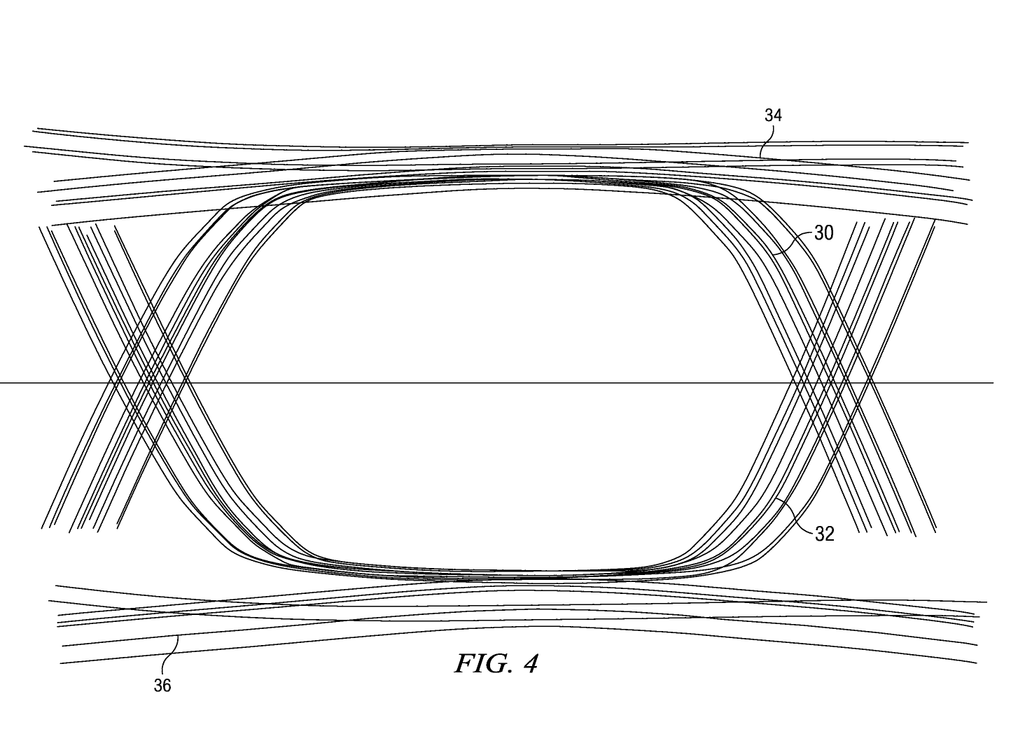

With reference now to FIG. 4, typical differential CA signals are shown at 30 and 32 as would be switched onto the post-register CA bus 22 by register 16. At 34 and 36 complementary “static” signals are shown which would result from tying a bus line to either of the opposite supply terminals of the memory module. Bearing in mind that the post-register CA bus 22 is terminated by resistors connected to a voltage level that is approximately half of the supply voltage, it is seen that power dissipation is considerably less when the bus lines are switched than when they are kept at either of the supply levels. Accordingly, by keeping the register switching the CA signals independent of the chip select signal, power dissipation is reduced and the system speed can be increased.

What is claimed is:

1. A memory system comprising:
a memory controller;
one or more registered memory modules coupled to the memory controller, each registered memory module having a bank of memory chips and an associated register;
a pre-register address/command bus connecting the memory controller with the associated register of the one or more registered memory modules; and
a post-register command/address bus connecting in parallel the bank of memory chips with the associated register of the one or more registered memory modules, the post-register command/address bus terminating with termination resistors that are coupled to a voltage level that is approximately half of the supply voltage level of the one or more registered memory modules;
wherein the memory controller provides chip select signals to the associated register of the one or more registered memory modules, and the associated register of the one or more registered memory modules switches command/address signals to the bank of memory chips independent of a state of the chip select signals.

2. A memory system comprising:
a memory controller;
one or more registered memory modules coupled to the memory controller to receive command/address signals from the memory controller, each of the one or more registered memory modules having a bank of memory chips; and
a register located within each of the one or more registered memory modules, the register switching the command/address signals to the bank of memory chips of the one or more registered memory modules irrespective of an active or inactive state of chip select signals applied to the register by the memory controller.
